(19) United States
(12) Patent Application Publication
(10) Pub. No.: US 2008/0172837 A1
(43) Pub. Date: Jul. 24, 2008

(54) Device for a Screen

(76) Inventors: Dag Goranson, Falkenberg (SE); Orjan Goranson, Falkenberg (SE)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 11/578,776

(22) PCT Filed: Apr. 27, 2005
(86) PCT No.: PCT/SE2005/000618

§ 371 Date: Oct. 18, 2006

(30) Foreign Application Priority Data
May 5, 2004 (SE) 0401171-4

(51) Int. Cl. E05D 11/08; E04B 2/74

(52) U.S. Cl. 16/343

(57) ABSTRACT

The present invention relates to an arrangement in a pivotal screen or screen section for substantially continuous adjustability and parking of the screen in the desired position, the screen or screen section being provided with an upper hinge and a lower hinge, and the lower hinge being provided with a conicity for achieving a braking effect against pivoting of the parts in relation to one another.

The present invention relates to an arrangement according to the preamble to appended claim 1.

An arrangement of the above-mentioned type is particularly usable in mobile screens that are exemplified in Swedish Registered Design 69367 which shows a fixed screen on a wheeled frame and two pivotal screens or screen parts on either side thereof. The prior art pivots or hinges have proved to suffer from various drawbacks, for example numerous moving parts that are excessively expensive, suffer from defective service life, etc. There is thus a need in the art for an improved hinge which is more economical and displays considerably longer service life, in particular from the functional viewpoint.

Thus, the task forming the basis of the present invention is to satisfy the above-outlined needs.

This task is solved by the present invention in the arrangement disclosed by way of introduction in that it has been given the characterising features as set forth in appended claim 1.

The present invention realises a hinge with a desirable braking function which moreover may be selected in a simple manner and thereby be adapted to different desirable conditions. After the selected braking function, this will, in principle, be constant and need not be adjusted while being used. Further, the constant braking effect will, in principle. be self-adjusting. A plurality of the parts included in the hinge entails simple assembly and thereby lower cost. Moreover, the present invention makes for superior design and hygienic form, which is of particular importance in the use of the product in the medical care sector and the like.

The present invention will be described in greater detail hereinbelow with reference to the accompanying drawings.

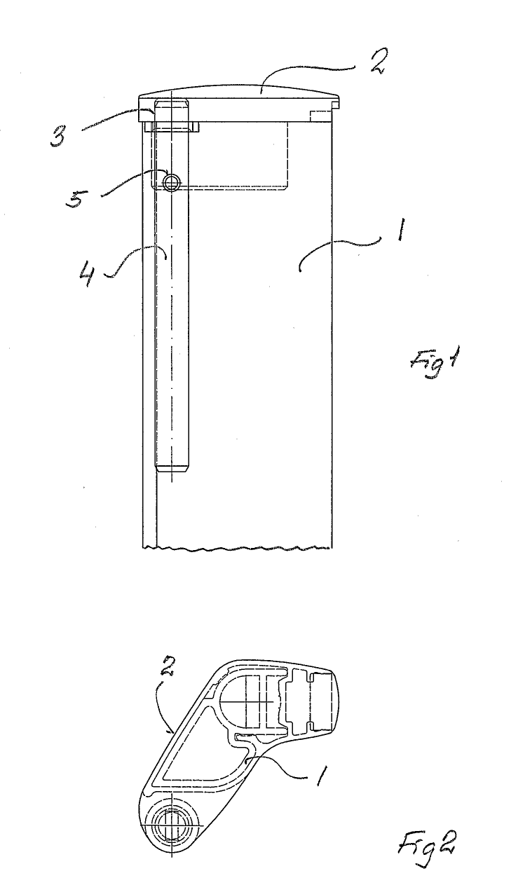

FIG. 1 is a view of an upper hinge section of the arrangement according to the present invention.

FIG. 2 shows the part illustrated in FIG. 1 from above.

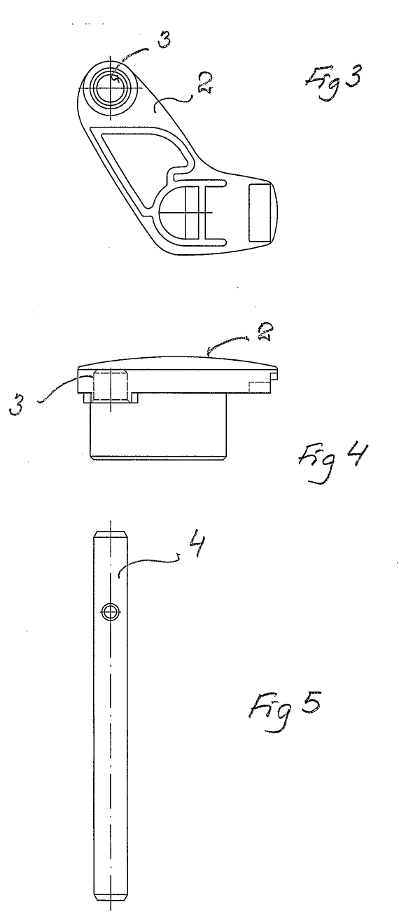

FIG. 3 shows the part illustrated in FIG. 1 from beneath.

FIG. 4 is a view of an upper portion of the part illustrated in FIG. 1.

FIG. 5 is a view of a shaft included in the part illustrated in FIG. 1.

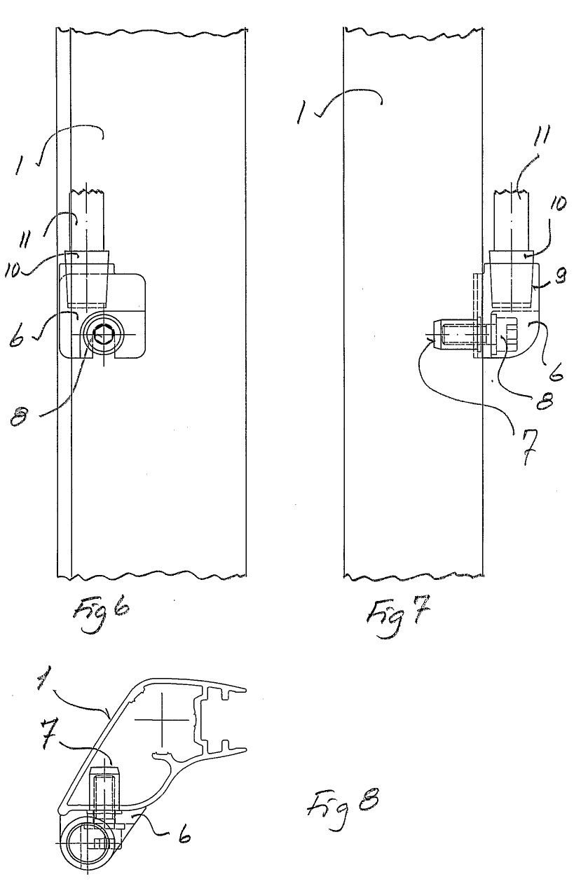

FIG. 6 is a front elevation of a further part of the arrangement according to the present invention.

FIG. 7 is a side elevation of the part according to FIG. 6.

FIG. 8 is a top plan view of the part according to FIG. 6.

FIG. 9 is a view of a part of the lower hinge section of the arrangement according to the present invention.

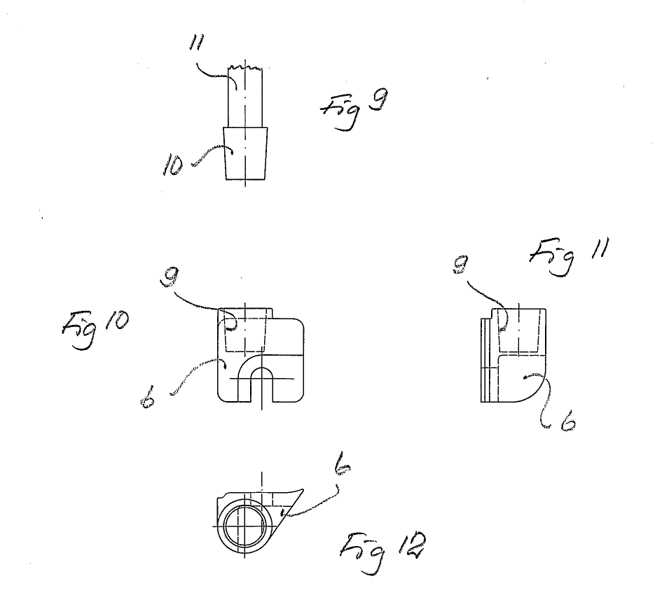

FIG. 10 is a front elevation of another part of the lower hinge section of the arrangement according to the present invention.

FIG. 11 is a side elevation of the part according to FIG. 10.

FIG. 12 is a top plan view of the part according to FIGS. 10 and 11.

In the different Figures, the same parts carry the same reference numerals. The embodiment of an arrangement according to the present invention illustrated in the Drawings will be described in greater detail in the practical application thereof on a mobile screen of the type which constitutes the subject matter of Swedish Registered Design 69367 which displays a fixed screen on a wheeled frame and two pivotal screens or screen sections on either side of the fixed screen.

The vertical edges of the fixed screen are provided with an aluminium profile 1 which is provided at the top with a plug 2 which appropriately may be manufactured from a plastic material. The plug 2 fits in the profile 1 and closes it upwardly. The plug 2 further has an anchorage 3 for an upper hinge shaft 4 which is cylindrical and fixed in a pivotal screen section by means of a cross pin 5. The plug 2 is shown from beneath in FIG. 3 and from the side in FIG. 4. Further, the hinge shaft 4 is shown in FIG. 5.

The arrangement according to the present invention moreover includes a lower hinge section which is shown in greater detail in FIGS. 6 to 12. In this lower hinge section, there is included a female part 6 which is secured on the profile 1 with the aid of a rivet nut 7 and a screw 8. The female part 6 has an upwardly directed conical hole 9 which is intended for a conical end portion 10 on a shaft 11 which is secured in the movable or pivotal screen section.

The female part 6 is shown in greater detail in FIGS. 10 and 11 and the male part 10, 11 is shown in greater detail in FIG. 9. The conicity of the hole 9 and on the end portion 10 may, for example, be 6° but it is naturally possible to select any desired conicity whatever depending on the properties that are desired as regards frictional forces or braking force. The female part 6 may be manufactured from reinforced nylon, but it naturally conceivable to employ many other types of materials, depending on the desired properties of the hinge.

As a result of an arrangement according to the present invention, it is possible to set the pivotal screen sections in any desired position whatever.

Many modifications are naturally possible without departing from the scope of the inventive concept as defined in the appended Claims.

1. An arrangement in a pivotal screen or screen section for substantially continuous adjustability and parking of the screen in the desired position, the screen or screen section being provided with an upper hinge and a lower hinge, wherein the lower hinge is provided with a conicity for achieving a braking effect against pivoting of the parts in relation to one another.

2. The arrangement as claimed in claim 1, wherein the lower hinge includes at least one male part and female part which are at least partly conical.

3. The arrangement as claimed in claim 2, wherein the male part is mounted on the screen or screen section, while the female part is mounted on a frame, or a wall for accommodating at least a part of the weight of the screen or screen section via the male part for achieving a desired frictional force between the male and the female part for counteracting pivoting of the parts in relation to one another.
